(19) United States
(12) Patent Application Publication
(10) Pub. No.: US 2018/0089581 A1
(43) Pub. Date: Mar. 29, 2018

(54) APPARATUS AND METHOD FOR DATASET MODEL FITTING USING A CLASSIFYING ENGINE

(71) Applicant: Futurewei Technologies, Inc., Plano, TX (US)

(72) Inventors: Hui Zang, Cupertino, CA (US); Yiming Kong, San Jose, CA (US)

(21) Appl. No.: 15/277,970

(22) Filed: Sep. 27, 2016

(51) Int. Cl. G06N 99/00; G06N 5/02

(52) U.S. Cl. CPC G06N 99/005; G06N 5/022

(57) ABSTRACT

An apparatus and method are provided for dataset model fitting, and using a classifying engine to identify a statistical distribution for the dataset. The dataset classifying engine is configured to calculate a characterization function that represents a dataset and compute a feature vector for the dataset, where the feature vector encodes slope value changes corresponding to the characterization function. The dataset classifying engine receives a classification model and applies the classification model to the feature vector to identify a statistical distribution for the dataset.

### FIELD OF THE INVENTION

The present invention relates to dataset model fitting, and more particularly to using a classifying engine to identify a statistical distribution for the dataset.

### BACKGROUND

Determining a distribution of a given dataset is important to applications, particularly in the telecom industry. Example datasets can include call durations in a month for each user in a cellular network or durations of each call over one month for calls made by one user in a cellular network. Example distributions include exponential, chi-squared, power-law (PL), lognormal (LN), and double-pareto lognormal (DPLN). Parameters associated with the distribution that is identified for a dataset are specific to the distribution. For example, the parameters associated with a PL distribution are not necessarily the same parameters as are associated with a LN distribution. Conventional fitting techniques compute parameter values for each candidate distribution to best match the candidate distribution to the dataset.

FIG. 1 is a flowchart of a prior art method 100 for dataset model fitting. At step 110 a dataset is received. At steps 120(1) through 120(G), parameters of candidate distributions D₁, D₂, . . . D_{G} are estimated using a maximum likelihood estimation (MLE) technique. As shown in FIG. 1, the dataset is fitted to G different candidate distributions. Computation of the parameters is time-consuming, particularly when distributions for large numbers of datasets need to be determined.

At steps 130(1) through 130(G), a residual sum of squares (RSS) is evaluated between the estimated distributions D₁, D₂, . . . D_{G} each with estimated parameters and the dataset. The RSS for each estimated distribution indicates deviations between the estimated distribution and the dataset. Therefore, for each RSSᵢ, i=1, 2, . . . , G, indicates a quality of a corresponding estimated distribution. At step 140, the estimated distribution D₁, D₂, . . . D_{G} having the minimum RSS is selected as the statistical distribution of the dataset.

Estimating the parameters for multiple distributions for each dataset requires a long processing time or parallel computations, especially when there are many datasets to be modeled. It is desirable to reduce the amount of time needed to determine the distribution(s) of such dataset(s).

### SUMMARY

A classifying engine, computer readable medium, and method are provided for model fitting for a dataset. Classification comprises determining a statistical distribution for any random variable by analyzing a plurality of samples of the random variable, where the plurality of samples is a dataset. Components of a classifying system may include one or more processors in communication with a memory storage, where the one or more processors execute the classifying engine. In one embodiment, the one or more processors execute a training engine to train a classification model with a set of candidate statistical distributions. The dataset classifying engine is configured to calculate a characterization function that represents a dataset, and compute a feature vector for the dataset, where the feature vector encodes slope value changes corresponding to the characterization function. The dataset classifying engine receives the classification model and applies the classification model to the feature vector to identify a statistical distribution for the dataset.

In a first embodiment, the characterization function is a complementary cumulative distribution function (CCDF).

In a second embodiment (which may or may not be combined with the first embodiment), points are identified on a plot of the characterization function.

In a third embodiment (which may or may not be combined with the first and/or second embodiments), a log scale is used on an x-axis of the plot and a log scale is used on a y-axis of the plot.

In a fourth embodiment (which may or may not be combined with the first, second, and/or third embodiments), a first point and a last point of the points are discarded, a slope value is computed for each pair of adjacent points forming a segment, and a difference between each pair of slope values is computed to produce the slope value changes.

In a fifth embodiment (which may or may not be combined with the first, second, third, and/or fourth embodiments), the statistical distribution is a power-law distribution, a lognormal distribution, or a double-pareto lognormal distribution.

In a sixth embodiment (which may or may not be combined with the first, second, third, fourth, and/or fifth embodiments), parameters are estimated for the statistical distribution.

In a seventh embodiment (which may or may not be combined with the first, second, third, fourth, fifth, and/or sixth embodiments), a residual sum of squares between the statistical distribution and the dataset is evaluated.

In an eighth embodiment (which may or may not be combined with the first, second, third, fourth, fifth, sixth, and/or seventh embodiments), the classification model is trained using at least one of a power-law distribution, a lognormal distribution, and a double-pareto lognormal distribution.

In a ninth embodiment (which may or may not be combined with the first, second, third, fourth, fifth, sixth, seventh, and/or eighth embodiments), the classification model is trained using randomly generated training datasets, and wherein during training of the classification model, a training feature vector is computed for each training dataset.

In a tenth embodiment (which may or may not be combined with the first, second, third, fourth, fifth, sixth, seventh, eighth, and/or ninth embodiments), the classification model is trained by calculating a training characterization function that represents a training dataset and computing a training feature vector for the training dataset, wherein the training feature vector encodes slope value changes corresponding to the training characterization function.

In an eleventh embodiment (which may or may not be combined with the first, second, third, fourth, fifth, sixth, seventh, eighth, ninth, and/or tenth embodiments), the classification model is further trained by identifying points on a plot of the training characterization function, discarding a first point and a last point of the points, computing a training slope value for each pair of adjacent points that form a segment, and computing the training feature vector for the training dataset based on the points, where the training feature vector encodes training slope value changes.

To this end, in some optional embodiments, one or more of the foregoing features of the aforementioned apparatus, system and/or method may, identify a statistical distribution for a dataset. The statistical distribution may be identified using a trained classification model based on a feature vector without fitting multiple candidate distributions to the dataset by estimating parameter values for each one of the multiple candidate distributions.

This may, in turn, reduce the time consumed to identify the statistical distribution for the dataset compared with systems that lack such identification mechanisms. It should be noted that the aforementioned potential advantages are set forth for illustrative purposes only and should not be construed as limiting in any manner.

### BRIEF DESCRIPTION OF THE DRAWINGS

FIG. 1 is a flowchart of a prior art method for dataset model fitting.

FIG. 2A is a flowchart of a method for using a classifying engine to identify a statistical distribution for a dataset, in accordance with one embodiment.

FIG. 2B illustrates a dataset classifying system, in accordance with one embodiment.

FIG. 3A is a graph of an empirical probability mass function (PMF) of the dataset, in accordance with one embodiment.

FIG. 3B is a graph of the PMF of a discrete power-law distribution with parameters fitted to the dataset using MILE and the empirical PMF of the dataset shown in FIG. 3A, in accordance with one embodiment.

FIG. 3C is a graph of the PMF of a discrete lognormal distribution with parameters fitted to the dataset using MLE and the empirical PMF of the dataset shown in FIG. 3A, in accordance with one embodiment.

FIG. 3D is a graph of the PMF of a discrete double-pareto lognormal distribution with parameters fitted to the dataset using MILE and the empirical FAIT of the dataset shown in FIG. 3A, in accordance with one embodiment.

FIG. 4 is a flowchart of a method for training a classification model, in accordance with one embodiment.

FIG. 5A is a flowchart of a method for computing a feature vector for a dataset, in accordance with one embodiment.

FIG. 5B illustrates a plot of the CCDF of the dataset used to calculate at least a portion of the feature vector for the dataset whose empirical PMF is shown in FIG. 3A, in accordance with one embodiment.

FIG. 6 is a flowchart of a method for identifying a statistical distribution for the dataset and estimating parameters, in accordance with one embodiment.

FIG. 7 illustrates an exemplary processing system, in accordance with one embodiment.

### DETAILED DESCRIPTION

In one embodiment, a statistical distribution is identified for a dataset using a classifying engine. In one embodiment, prior to receiving a dataset for classification, a classification model is trained using training datasets generated based on multiple statistical distributions. In one embodiment, during training, a feature vector is computed for each training dataset. In one embodiment, after training, the classification model is used by the classifying engine to identify one of the statistical distributions as the statistical distribution. In one embodiment, the classifying engine computes a feature vector for the dataset that is received and then applies the classification model to the feature vector to identify one of the statistical distributions as the statistical distribution for the dataset.

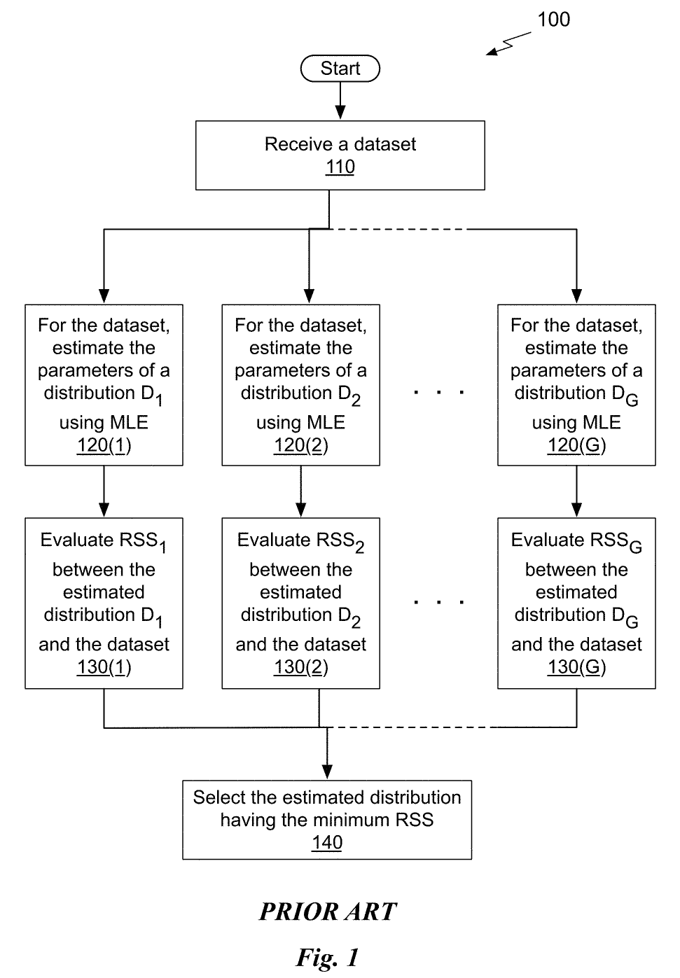

In contrast with the prior art technique shown in FIG. 1 that estimates parameter values for multiple candidate distributions and computes a deviation for each of the multiple candidate distributions, the classifying engine discussed herein identifies one statistical distribution without estimating parameter values for multiple candidate distributions. Therefore, the processing time needed to identify the statistical distribution for the dataset is reduced. In one embodiment, parameter values for the statistical distribution that is identified for the dataset are estimated after the statistical distribution is identified by the classifying engine. In one embodiment, the maximum likelihood estimation (MLE) technique is used to estimate the parameter values for the statistical distribution that is identified for the dataset.

More illustrative information will now be set forth regarding various optional architectures and uses in which the foregoing technique may or may not be implemented, in accordance with other embodiments. It should be strongly noted that the following information is set forth for illustrative purposes and should not be construed as limiting in any manner. Any of the following features may be optionally incorporated with or without other features described.

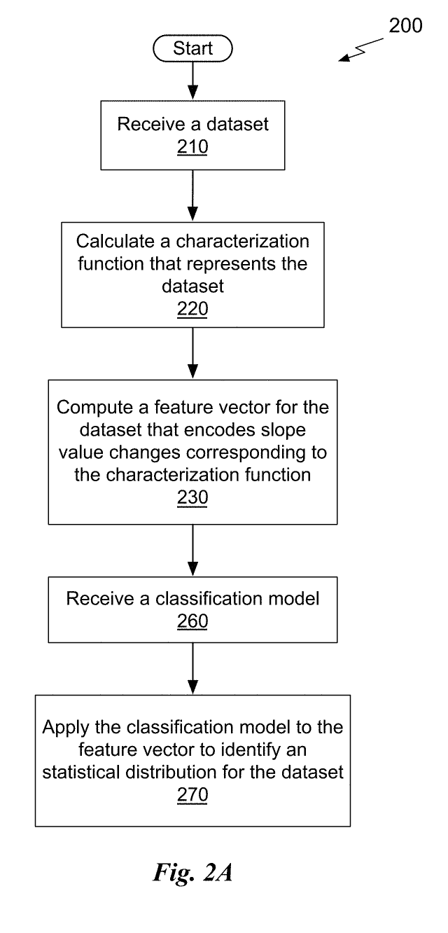

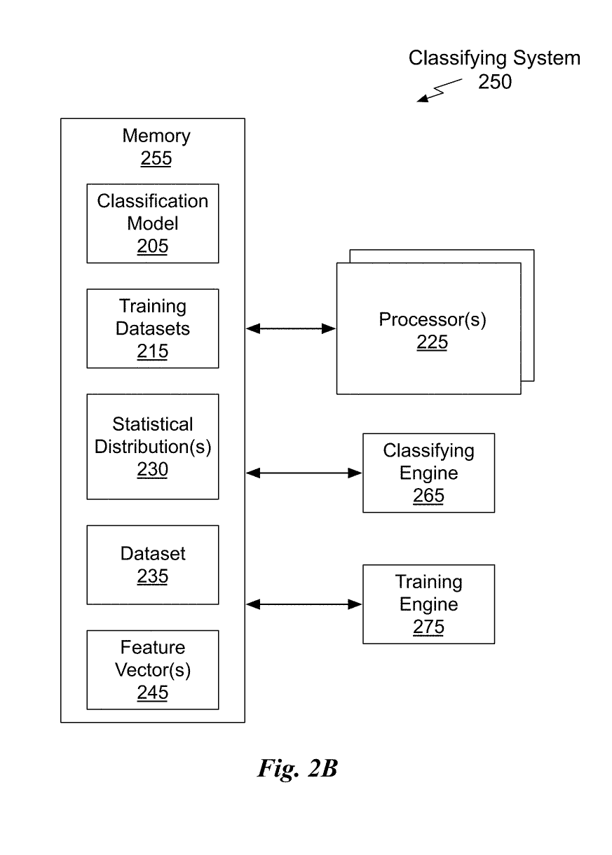

FIG. 2A is a flowchart of a method 200 for using a classifying engine to identify a statistical distribution for a dataset, in accordance with one embodiment. As an option, the method 200 may be implemented in the context of any one or more of the embodiments set forth in any previous and/or subsequent figure(s) and/or description thereof. For example, the method 200 may be implemented for identifying a statistical distribution for a dataset in the context of the classifying system 250 of FIG. 2B or any other embodiment. Although the steps shown in FIG. 2A are described in the context of a program executed by a processor, the steps shown in FIG. 2A may also be performed by custom circuitry or by a combination of custom circuitry and a program.

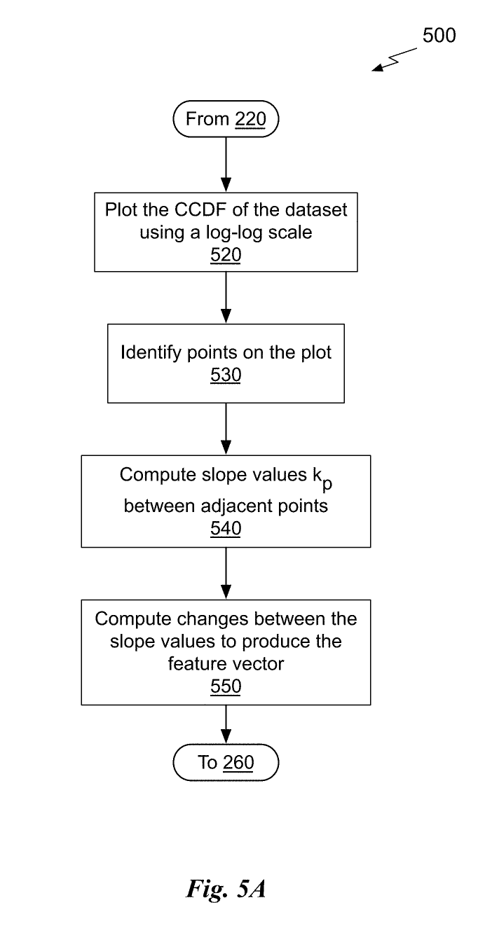

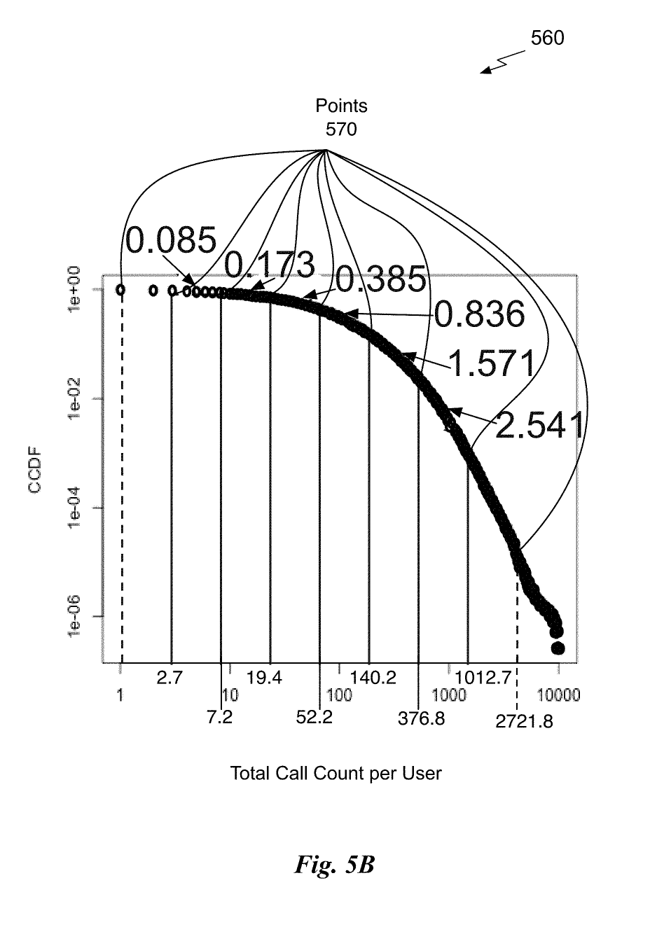

At step 210, a classifying engine receives a dataset. At step 220, the classifying engine calculates a characterization function that represents the dataset. In one embodiment, the characterization function is a complementary cumulative distribution function (CCDF). At step 230, the classifying engine computes a feature vector for the dataset, as described in more detail in conjunction with FIGS. 5A and 5B. In one embodiment, the feature vector encodes slope value changes that correspond to the characterization function. In one embodiment, the slope value changes are computed based on points on a plot of the characterization function. In one embodiment, the feature vector encodes slope value changes associated with pairs of adjacent points.

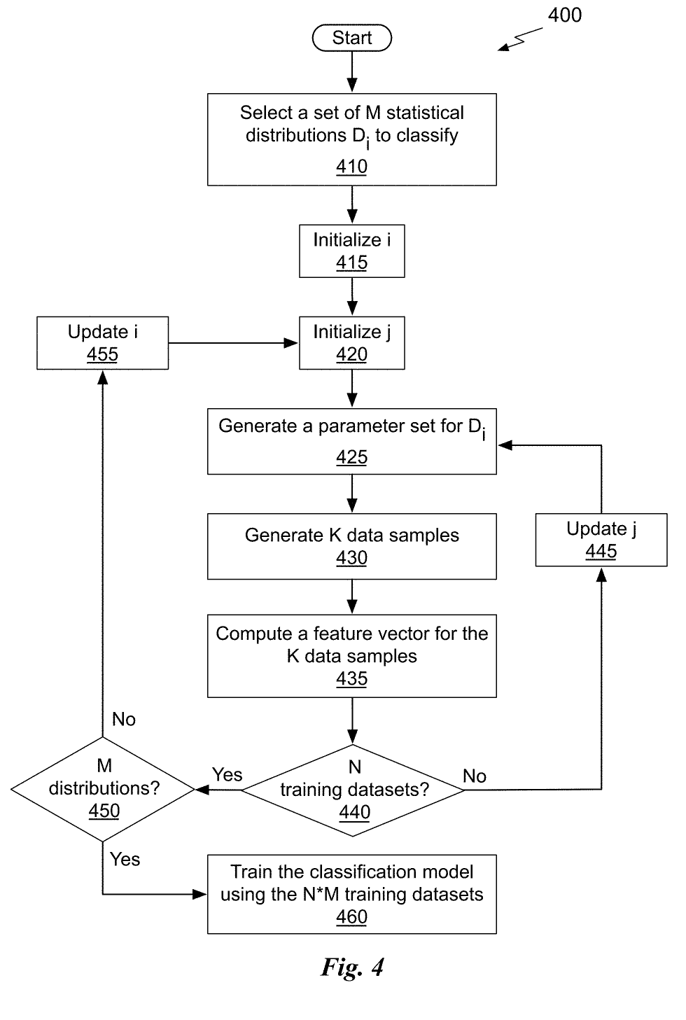

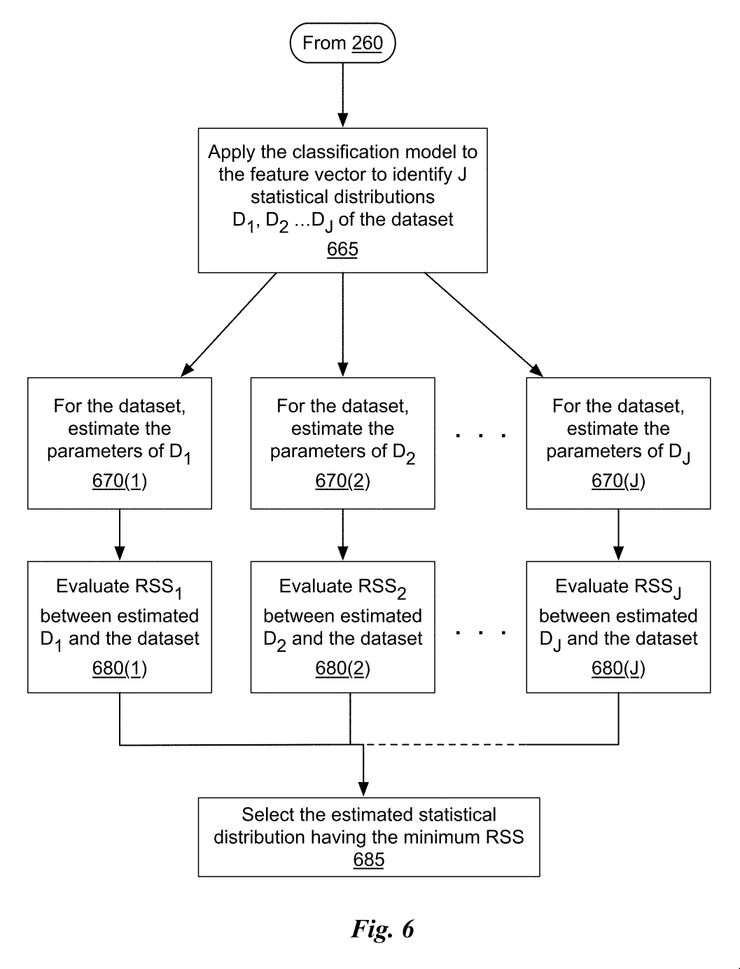

At step 260, the classifying engine receives a classification model. In one embodiment, the classification model has been trained by a training engine using training datasets generated based on multiple statistical distributions, as described in detail in conjunction with FIG. 4. At step 270, the classifying engine applies the classification model to the feature vector to identify a statistical distribution for the dataset, as described in detail in conjunction with FIG. 6.

The classifying engine is a function that receives a dataset with unknown distribution and a classification model as inputs, and outputs one or several best fitted statistical distribution(s) for the dataset. Additional details of the classifying engine are described in conjunction with FIG. 2A.

The training engine is a function that receives a set of M candidate distributions (e.g., PL distribution, distribution, and DPLN distributions, and M=3), and a classifier method (e.g., random forest) as inputs, and outputs a classification model (e.g. a trained random forest). Additional details of the training engine are described in conjunction with FIG. 4.

FIG. 2B illustrates a dataset classifying system 250, in accordance with one embodiment. The dataset classifying system 250 includes a classifying engine 265, a training engine 275, a memory 255, and one or more processors 225. The memory 255 may store one or more of a classification model 205, statistical distributions 230, training datasets 215, a dataset 235 to be classified, and feature vector(s) 245. In the context of the present classifying system 250, the classifying engine 265 may take any form including, but not limited to executable instructions stored in a computer readable medium for use by or in connection with an instruction execution machine, apparatus, or device, such as a computer-based or processor-containing machine, apparatus, or device. For example, in one embodiment, the classifying engine 265 is stored in the memory 255 and is executed by the processor(s) 225. In one embodiment, the classifying engine 265 may be implemented as logic and/or circuitry configured to perform the operations of the executable instructions. As an option, the classifying engine 265 may be implemented in the context of any one or more of the embodiments set forth in any subsequent figure(s) and/or description thereof. However, it is to be appreciated that the classifying engine 265 may be implemented in the context of any desired environment.

In the context of the present classifying system 250, the training engine 275 may take any form including, but not limited to executable instructions stored in a computer readable medium for use by or in connection with an instruction execution machine, apparatus, or device, such as a computer-based or processor-containing machine, apparatus, or device. For example, in one embodiment, the training engine 275 is stored in the memory 255 and is executed by the processor(s) 225. In one embodiment, the training engine 275 may be implemented as logic and/or circuitry configured to perform the operations of the executable instructions. As an option, the training engine 275 may be implemented in the context of any one or more of the embodiments set forth in any subsequent figure(s) and/or description thereof. However, it is to be appreciated that the training engine 275 may be implemented in the context of any desired environment.

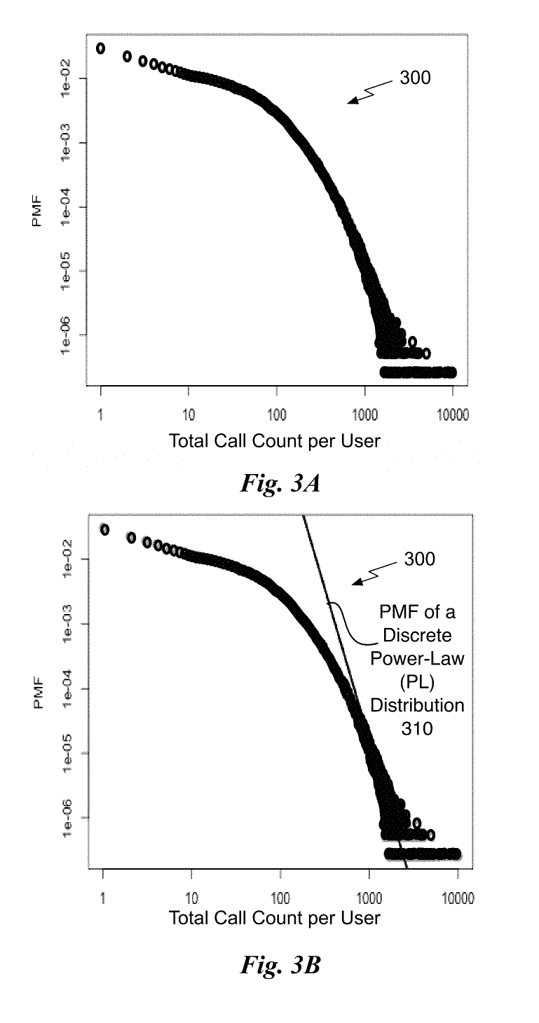

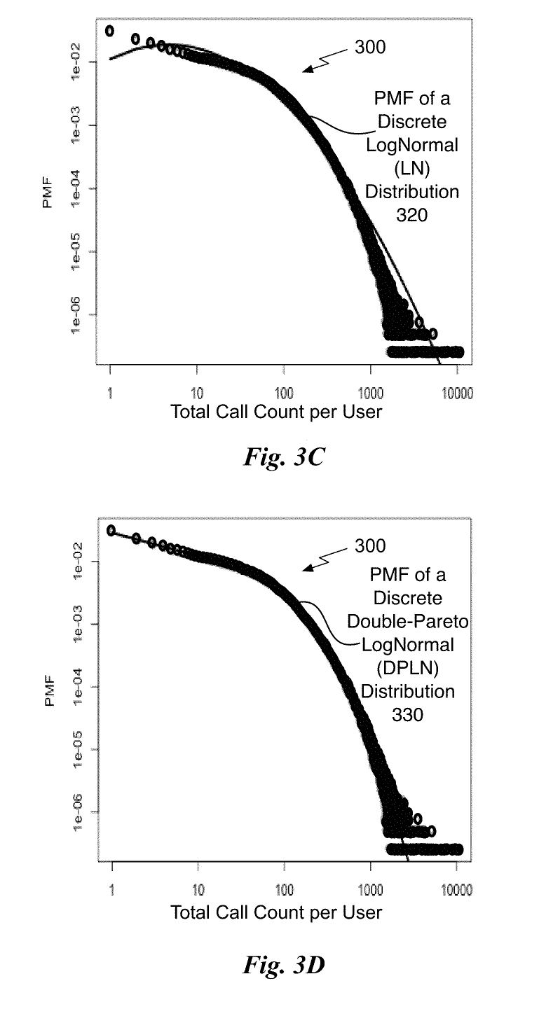

FIG. 3A is a graph of an empirical probability mass function (PMF) 300 of a dataset, in accordance with one embodiment. The PMF of a discrete random variable illustrates the probability distribution of the discrete random variable, or provides a “summary” of the discrete random variable. The vertical axis is the value of PMF in a log scale and the horizontal axis is a total call count per each user of a cellular network, represented using a log scale. The empirical PMF 300 of the dataset has non-zero values in a tail portion on the rightmost portion of the plot between x=1000 and 10,000. In other words, the dataset summarized by the empirical PMF 300 may be considered to be a plurality of samples of a discrete “heavytail” random variable.

FIG. 3B is a graph of the PMF of a discrete power-law (PL) distribution 310 with parameters fitted to the dataset using MLE and the empirical PMF 300 of the dataset shown in FIG. 3A, in accordance with one embodiment. The PMF of the discrete PL distribution 310 does not closely match the empirical PMF 300 of the dataset. In another embodiment, a continuous PL distribution is used in place of the discrete PL distribution 310 and the vertical axis is a probability density function (PDF). The PDF of a random variable may be used to illustrate the probability distribution of the continuous random variable, or provide “a summary” of the continuous random variable.

FIG. 3C is a graph of the PMF of a discrete lognormal (LN) distribution 320 with parameters fitted to the dataset using MLE and the empirical PMF 300 of the dataset shown in FIG. 3A, in accordance with one embodiment. In one embodiment, a discrete LN distribution is referred to as discrete Gaussian exponential (DGX) distribution. As can be seen from the figure, the PMF of the discrete LN distribution 320 is a closer match to the empirical PMF 300 of the dataset than the discrete PL distribution 310. In another embodiment, a continuous LN distribution is used in place of the discrete LN distribution 320 and the vertical axis is a probability density function (PDF).

FIG. 3D is a graph of the PMF of a discrete double-pareto lognormal (DPLN) distribution 330 with parameters fitted to the dataset using MLE and the empirical PMF 300 of the dataset shown in FIG. 3A, in accordance with one embodiment. As can be seen from the figure, the PMF of the discrete DPLN distribution 330 is a closer match to the distribution of the empirical PMF 300 of the dataset than either the LN distribution 320 or the discrete PL distribution 310. In another embodiment, a continuous double-pareto lognormal (DPLN) distribution is used in place of the discrete DPLN 320 and the vertical axis is a probability density function (PDF). In one embodiment, the classifying engine 265 identifies the DPLN distribution 330 for the dataset 235. The classification model 205 may be trained by the training engine 275 using one or more heavy or long tail distributions, such as the PL distribution 310, LN distribution 320, and the DPLN distribution 330 in addition to other distributions, all of which constitute the candidate statistical distributions. In particular, a heavy or long tail distribution may be identified for the dataset 235 by the classification model 205.

FIG. 4 is a flowchart of a method 400 for training a classification model 205, in accordance with one embodiment. As an option, the method 400 may be implemented in the context of any one or more of the embodiments set forth in any previous and/or subsequent figure(s) and/or description thereof. For example, the method 400 may be implemented for training a classification model 205 in the context of the classifying system 250 of FIG. 2B or any other embodiment. Although the steps shown in FIG. 4 are described in the context of a program executed by a processor, the steps shown in FIG. 4 may also be performed by custom circuitry or by a combination of custom circuitry and a program.

At step 410, a set of M statistical distributions Dᵢ is selected by the training engine 275 to train the classification model 205. In one embodiment, the classifying engine 265 is configured to train the classification model 205, wherein the classifying engine 265 performs the method 400. At step 415, the variable i is initialized to a starting value. In one embodiment, the starting value is 1. In another embodiment, the starting value is M or another value. The variable i is updated during the method 400 to produce M values, one for each of the M statistical distributions 230. In one embodiment, the M statistical distributions 230 are heavy or long tail distributions including, but not limited to, the PL distribution 310, LN distribution 320, or the DPLN distribution 330, as discussed above.

At step 420, the variable j is initialized to a starting value. In one embodiment, the starting value is 1. In another embodiment, the starting value is N or another value. The variable j is updated during the method 400 to produce N values, one for each of N training datasets 215. At step 425, the training engine 275 generates a parameter set including parameter values for the statistical distribution Dᵢ. Each parameter set that is generated includes parameters that are specific to the statistical distribution Dᵢ. The particular parameters for different statistical distributions are typically not the same.

At step 430, the training engine 275 randomly generates K data samples according to the parameter set for Dᵢ that was generated in step 425, to produce a training dataset 215. At step 435, the training engine 275 computes a feature vector 245 of length L for the K data samples. In one example, the feature vector 245 is of length L=50 for K=100,000 data samples. The feature vector 245 is a sequence of values, where each value is a difference between a pair of slope values. One or more feature vectors 245 may be computed for the dataset 235, where each feature vector is associated with a different characteristic of the data to be classified. Example characteristics include, but are not limited to, color, shape, weight, width, length, diameter, curvature, and the like.

At step 440, the training engine 275 determines if N training sets 215 have been generated for the statistical distribution Dᵢ, and, if not, at step 445j is updated (e.g., incremented or decremented) and steps 425, 430, 435, and 440 are repeated. If, at step 440, the training engine 275 determines that N training datasets 215 have been generated for the statistical distribution Dᵢ, then at step 450, the training engine 275 determines if features have been generated for M statistical distributions. If features have not been generated for M statistical distributions, then, at step 455, i is updated (e.g., incremented or decremented) and steps 420, 425, 430, 435, 440, and 450 are repeated for at least one more statistical distribution. If feature vectors 245 have been computed for M statistical distributions, then, the training engine 275 proceeds to step 460 and the classification model 205 is trained using the N*M training datasets 215. The classification model 205 may then be used by the classifying engine 265 to identify the statistical distribution for the dataset 235.

FIG. 5A is a flowchart of a method 500 for computing a feature vector 245 for the dataset 235, in accordance with one embodiment. In one embodiment, the method 500 may be used to perform step 230 of the method 200 shown in FIG. 2A. As an option, the method 500 may be implemented in the context of any one or more of the embodiments set forth in any previous and/or subsequent figure(s) and/or description thereof. For example, the method 500 may be implemented for training a classification model 205 in the context of the classifying system 250 of FIG. 2B or any other embodiment. Although the steps shown in FIG. 5A are described in the context of a program executed by a processor, the steps shown in FIG. 5A may also be performed by custom circuitry or by a combination of custom circuitry and a program.

At step 220, the classifying engine 265 calculates a characterization function that represents the dataset 235. The dataset 235 is a collection of samples of a random variable. In one embodiment, a complementary cumulative distribution function (CCDF) is a characterization function that summarizes the dataset 235. The CCDF may be referred to as an empirical distribution function. In another embodiment, a probability density function (PDF) is used to characterize the distribution of the random variable, or provide a “summary” of the random variable. Essentially, a characterization function of a random variable is computed from the dataset 235 (i.e., samples of the random variable). The statistical distribution of the random variable may be identified via the empirical CCDF (or PDF) that is computed for the dataset 235.

At step 520, the CCDF of the dataset is plotted using a log-log scale. An example plot 560 of the CCDF of the dataset 235 is shown in FIG. 5B. Using the log-log scale increases the resolution of the plot at the tail of the CCDF of the dataset 235. In other embodiments, the CCDF is plotted using a linear scale for the x and/or y axis.

At step 530, points on the plot 560 of the CCDF of the dataset 235 are identified by the classifying engine 265. In one embodiment, the classifying engine 265 identifies points along the x-axis that are evenly spaced in log scale. The points may be identified from the minimum value on x-axis to the maximum value on the x-axis. The number of points P may depend on the desired length L of the feature vector (P=L+4). In one embodiment, the first point and last point are discarded, and the remaining P−2 points are used to compute the length L feature vector.

At step 540, the classifying engine 265 computes slope values for each segment formed by a pair of adjacent points. At step 550, the classifying engine 265 computes differences between the slope values to compute the feature vector 245 for the dataset 235. The differences between the slope values correspond to the CCDF of the dataset 235. The classifying engine 265 then proceeds to step 260 of FIG. 2A.

FIG. 5B is a plot 560 of the CCDF of the dataset 235 used to calculate at least a portion of the feature vector 245 for the dataset 235 shown in FIG. 3A, in accordance with one embodiment. The vertical axis is the CCDF of the dataset 235 and the horizontal or x-axis is the total call count for each user. The classifying engine 265 identifies points 570 on the plot of the CCDF of the dataset 235. Each point of the points 570 corresponds to a different x value on the x-axis and kₚ is the slope of the line segment connecting each pair of adjacent points CCDF(xₚ) and CCDF(xₚ₊₁).

As shown in the plot 560 of the CCDF of the dataset 235, there are 9 evenly spaced (in log scale) points in the points 570. In one embodiment, the points 570 correspond to x coordinates 1, 2.7, 7.2, 19.4, 52.2, 140.2, 376.8, 1012.7, and 2721.8, in this example. The first and last points may be discarded before the slope values kₚ are computed, resulting in x coordinates 2.7, 7.2, 19.4, 52.2, 140.2, 376.8, and 1012.7 and respective y coordinates (in log scale) −0.065, −0.186, −0.433, −0.982, −2.175, −4.415, and −8.039, in this example. The magnitudes of the slope values for segments formed by each pair of adjacent points of the plot 560 are 0.085, 0.173, 0.385, 0.836, 1.571, and 2.541, as shown in FIG. 5B, in this example. Differences between the magnitudes of the slope values may be computed by the classifying engine 265 as 0.089, 0.212, 0.451, 0.734, and 0.970, in this example. Each difference is an element in at least a portion of the feature vector 245 for the dataset 235.

Rather than identifying only one statistical distribution for the dataset 235, the classifying engine 265 may be used to identify two or more estimated statistical distributions for the dataset 235. For example, the classification model 205 may be configured to identify J statistical distributions for the dataset 235, where the J statistical distributions are a first, second, third, etc., best fitting statistical distributions. Parameters may be estimated for each of the statistical distributions and the classifying engine 265 may select the best match as the statistical distribution for the dataset 235.

FIG. 6 is a flowchart of a method 600 for identifying a statistical distribution for the dataset 235 and estimating parameters, in accordance with one embodiment. In one embodiment, the method 600 may be performed after step 260 of the method 200 shown in FIG. 2A. As an option, the method 600 may be implemented in the context of any one or more of the embodiments set forth in any previous and/or subsequent figure(s) and/or description thereof. For example, the method 600 may be implemented for identifying a statistical distribution for the dataset 235 in the context of the classifying system 250 of FIG. 2B or any other embodiment. Although the steps shown in FIG. 6 are described in the context of a program executed by a processor, the steps shown in FIG. 6 may also be performed by custom circuitry or by a combination of custom circuitry and a program.

At steps 665, the classification model 205 is applied to the feature vector(s) 245 by the classifying engine 265 to identify two or more statistical distributions D₁, D₂, . . . , D_{J} for the dataset 235. At steps 670(1) through 670(J), the classifying engine 265 estimates parameters of the statistical distributions Dᵢ, i=1, 2, . . . , J. In one embodiment, the parameters are estimated using a maximum likelihood estimation (MLE) technique. As shown in FIG. 6, the dataset is fitted to J different statistical distributions.

At steps 680(1) through 680(J), the classifying engine 265 evaluates a residual sum of squares (RSS) between the estimated statistical distribution i=1, 2, . . . , J fitted using the estimated parameters and the dataset 235. The RSS for each estimated statistical distribution indicates deviations between the estimated statistical distribution Dᵢ and the dataset 235. Therefore, each RSSᵢ (i=1, 2, . . . , J) indicates a quality of a corresponding estimated statistical distribution Dᵢ (i=1, 2, . . . , J). At step 685, the classifying engine 265 selects the estimated statistical distribution Dᵢ having the minimum RSS as the statistical distribution of the dataset 235.

Identifying a single statistical distribution for a dataset using the classifying engine 265 is faster compared with computing an MLE for each candidate statistical distribution in order to select the best match for the dataset. Even when the classifying engine 265 identifies J statistical distributions, the method is faster compared with computing an MLE for M statistical distributions, assuming M>J. Therefore, a processor with less processing performance or lower power consumption may be used to execute the classifying engine 265 compared with when the prior art technique shown in FIG. 1 is used to select the estimated distribution for a dataset. Alternatively, the processing may be achieved in less time.

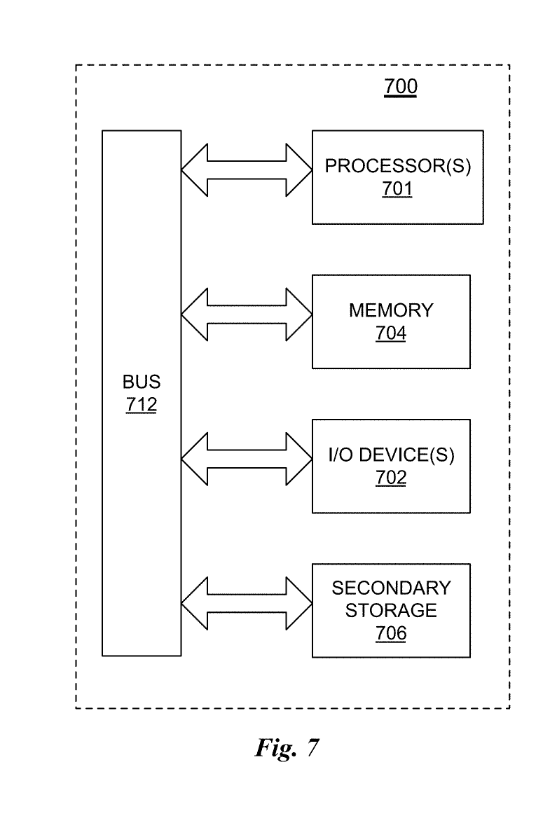

FIG. 7 illustrates an exemplary processing system 700, in accordance with one embodiment. As an option, the processing system 700 may be implemented in the context of any of the devices of the classifying system 250 of FIG. 2B. Of course, the processing system 700 may be implemented in any desired environment.

As shown, a processing system 700 is provided including one or more processors 701 that are connected to a bus 712. Such processors 701 may be used in connection with a classifying engine, such as the classifying engine 265, to identify a statistical distribution for a dataset. The processing system 700 also includes a memory 704 (e.g. random access memory (RAM), etc.). The processing system 700 may also include a secondary storage 706. The secondary storage 706 includes, for example, a hard disk drive and/or a removable storage drive, a floppy disk drive, a magnetic tape drive, a compact disk drive, etc. The removable storage drive reads from and/or writes to a removable storage unit in a well-known manner. The processing system 700 may also include input/output (I/O) device(s) 702. Output devices may include a conventional CRT (cathode ray tube), LCD (liquid crystal display), LED (light emitting diode), plasma display or the like. User input may be received from the I/O device(s) 702, e.g., keyboard, mouse, touchpad, microphone, gaze tracking, and the like.

Computer programs, or computer control logic algorithms, may be stored in the memory 704, the secondary storage 706, and/or any other memory, for that matter. Such computer programs, when executed, enable the processing system 700 to perform various functions (as set forth above including, but not limited to those of a classifying engine, for example). Memory 704, secondary storage 706 and/or any other storage are possible examples of tangible computer-readable media.

In one example, the processing system 700 comprises a classifying engine comprising a non-transitory memory storage 704 comprising instructions and one or more processors 701 in communication with the non-transitory memory storage 704. The one or more processors 701 execute the instructions to calculate a characterization function that represents a dataset, compute a feature vector for the dataset, wherein the feature vector encodes slope value changes corresponding to the characterization function, receive a classification model, and apply the classification model to the feature vector to identify a statistical distribution for the dataset.

In some embodiments, the characterization function is a complementary cumulative distribution function (CCDF). In some embodiments, the one or more processors 701 execute the instructions to identify points on a plot of the characterization function. In some embodiments, a log scale is used on an x-axis of the plot and a log scale is used on a y-axis of the plot. In some embodiments, the one or more processors 701 execute the instructions to compute the feature vector by discarding a first point and a last point of the points, computing a slope value for each pair of adjacent points that form a segment, and computing a difference between each pair of slope values to produce the slope value changes. In some embodiments, the statistical distribution is a power-law distribution, a lognormal distribution, or a double-pareto lognormal distribution. In some embodiments, the one or more processors 701 execute the instructions to estimate parameters for the statistical distribution. In some embodiments, the one or more processors 701 execute the instructions to evaluate a residual sum of squares between the statistical distribution and the dataset. In some embodiments, the classification model is trained using at least one of a power-law distribution, a lognormal distribution, or a double-pareto lognormal distribution. In some embodiments, the classification model is trained using randomly generated training datasets and wherein, during training of the classification model, a training feature vector is computed for each training dataset. In some embodiments, the classification model is trained by calculating a training characterization function that represents a training dataset, and computing a training feature vector for the training dataset, wherein the feature vector encodes slope value changes corresponding to the training characterization function. In some embodiments, the classification model is further trained by identifying points on a plot of the training characterization function, discarding a first point and a last point of the points, computing a training slope value for each pair of adjacent points that form a segment, and computing the training feature vector for the training dataset based on the points, wherein the training feature vector encodes training slope value changes.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), or the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, or electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; or the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A classifying engine, comprising:
a non-transitory memory storage comprising instructions; and
one or more processors in communication with the non-transitory memory storage, wherein the one or more processors execute the instructions to:
calculate a characterization function that represents a dataset;
compute a feature vector for the dataset, wherein the feature vector encodes slope value changes corresponding to the characterization function;
receive a classification model; and
apply the classification model to the feature vector to identify a statistical distribution for the dataset.

2. The classifying engine of claim 1, wherein the characterization function is a complementary cumulative distribution function (CCDF).

3. The classifying engine of claim 2, wherein, the one or more processors execute the instructions to identify points on a plot of the characterization function.

4. The classifying engine of claim 3, wherein a log scale is used on an x-axis of the plot and a log scale is used on a y-axis of the plot.

5. The classifying engine of claim 3, wherein the one or more processors execute the instructions to compute the feature vector by:
discarding a first point and a last point of the points;
computing a slope value for each pair of adjacent points that form a segment; and
computing a difference between each pair of slope values to produce the slope value changes.

6. The classifying engine of claim 1, wherein the statistical distribution is a power-law distribution, a lognormal distribution, or a double-pareto lognormal distribution.

7. The classifying engine of claim 1, wherein the one or more processors execute the instructions to estimate parameters for the statistical distribution.

8. The classifying engine of claim 6, wherein the one or more processors execute the instructions to evaluate a residual sum of squares between the statistical distribution and the dataset.

9. The classifying engine of claim 1, wherein the classification model is trained using at least one of a power-law distribution, a lognormal distribution, or a double-pareto lognormal distribution.

10. The classifying engine of claim 1, wherein the classification model is trained using randomly generated training datasets and wherein, during training of the classification model, a training feature vector is computed for each training dataset.

11. The classifying engine of claim 1, wherein the classification model is trained by:
calculating a training characterization function that represents a training dataset; and
computing a training feature vector for the training dataset, wherein the feature vector encodes slope value changes corresponding to the training characterization function.

12. The classifying engine of claim 11, wherein the classification model is further trained by:
identifying points on a plot of the training characterization function;
discarding a first point and a last point of the points;
computing a training slope value for each pair of adjacent points that form a segment; and
computing the training feature vector for the training dataset based on the points, wherein the training feature vector encodes training slope value changes.

13. A method, comprising:
receiving a dataset, by a classifying engine;
calculating, by the classifying engine, a characterization function that represents the dataset;
computing, by the classifying engine, a feature vector for the dataset, wherein the feature vector encodes slope value changes corresponding to the characterization function;
receiving a classification model, by the classifying engine; and
applying the classification model to the feature vector, by the classifying engine, to identify a statistical distribution for the dataset.

14. The method of claim 13, wherein the characterization function is a complementary cumulative distribution function (CCDF).

15. The method of claim 14, wherein, the one or more processors execute the instructions to identify points on a plot of the characterization function.

16. The method of claim 15, wherein a log scale is used on an x-axis of the plot and a log scale is used on a y-axis of the plot.

17. The method of claim 15, wherein, the one or more processors execute the instructions to compute the feature vector by:
discarding a first point and a last point of the points;
computing a slope value for each pair of adjacent points that form a segment; and
computing a difference between each pair of slope values to produce the slope value changes.

18. The method of claim 13, wherein the statistical distribution is a power-law distribution, a lognormal distribution, or a double-pareto lognormal distribution.

19. The method of claim 13, wherein the one or more processors execute the instructions to estimate parameters for the statistical distribution.

20. The method of claim 18, wherein the one or more processors execute the instructions to evaluate a residual sum of squares between the statistical distribution and the dataset.

21. The method of claim 13, wherein the classification model is trained using at least one of a power-law distribution, a lognormal distribution, or a double-pareto lognormal distribution.

22. The method of claim 13, wherein the classification model is trained using randomly generated training datasets and wherein, during training of the classification model, a training feature vector is computed for each training dataset.

23. The method of claim 13, wherein the classification model is trained by:
calculating a training characterization function that represents a training dataset; and
computing a training feature vector for the training dataset, wherein the feature vector encodes slope value changes corresponding to the training characterization function.

24. The method of claim 23, wherein the classification model is further trained by:
identifying points on a plot of the training characterization function;
discarding a first point and a last point of the points;
computing a training slope value for each pair of adjacent points that form a segment; and
computing the training feature vector for the training dataset based on the points, wherein the training feature vector encodes training slope value changes.

25. A non-transitory computer-readable media storing computer instructions, that when executed by one or more processors, cause the one or more processors to perform the steps of:
receiving a dataset;
calculating a characterization function that represents the dataset;
computing a feature vector for the dataset, wherein the feature vector encodes slope value changes corresponding to the characterization function;
receiving a classification model; and
applying the classification model to the feature vector to identify a statistical distribution for the dataset.
